(19) United States
(12) Patent Application Publication
(10) Pub. No.: US 2007/0127230 A1
(43) Pub. Date: Jun. 7, 2007

(54) Molding light box and assembly

(76) Inventors: Chien-Wen Chung, Tainan City (TW); Chia-Li Lin, Yong Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,135

(22) Filed: Dec. 5, 2005

(51) Int. Cl. G09F 13/04

(52) U.S. Cl. 362/97

(57) ABSTRACT

A molding light box and assembly includes a lighting source in each box. The lighting source comprises an input terminal and an output terminal to connect the boxes together and to transmit power supply and signal. A control unit is connected to control the light sources in all of the boxes to turn them on/off, blinking and the strength of the illumination, etc.

### BACKGROUND OF THE INVENTION

1. Field of the Invention

The present invention relates to a molding light box and assembly, in particular to a light source in each box having an input terminal and an output terminal to connect each box for power and signal transmission. A control unit is connected to control change of the light source in each box.

2. Description of Prior Art

Currently, an advertiser uses one box with a lighting device therein to illustrate pictures or wording as propaganda. However, this box is made of independent. If the user wants to have more than one box, they have to be custom, which takes time and requires adjustment in order to have a coherence display.

### SUMMARY OF THE INVENTION

According to the invention there is provided a molding light box comprising a box having an inner space, said box comprising at least one shining surface; a light source disposed in said inner space, said light source comprising light emitting diodes; an input terminal connected to said light source for inputting power supply and signal; and an output terminal connected to said light source for outputting power supply and signal.

According to the invention there is provided a molding light box assembly comprising a plurality of boxes, each box comprising an inner space to accommodate a light source, said light source comprising an input terminal and an output terminal, each box being connected by said input terminal and said output terminal for power and signal transmission; and a control unit to control change of said light sources of said boxes.

It is the primary object of the present invention to provide a molding light box and assembly which box may be added or decreased at any time as desired.

It is another object of the present invention to provide a molding light box and assembly which box is installed with light emitting diodes of various colors to shin in different colors.

It is a further object of the present invention to provide a molding light box and assembly which lighting, colors and illumination are controlled by a control unit to reach advertisement, display and propaganda purposes.

It is still a further object of the present invention to provide a molding light box and assembly, which may be connected with each other in series or parallel as many as desired.

### BRIEF DESCRIPTION OF THE DRAWINGS

FIG. 1 is a perspective view of the present invention;

FIG. 2 is a side view of the present invention showing reflection boards to reflect light;

FIG. 3 is another side view of the present invention showing the reflection boards to reflect light;

FIG. 4 is a diagram showing molding light box assembly of the present invention;

FIG. 5 is a second embodiment of molding light box assembly of the present invention; and

FIG. 6 is a third embodiment of molding light box assembly of the present invention.

### DETAILED DESCRIPTION OF THE PREFERRED EMBODIMENT

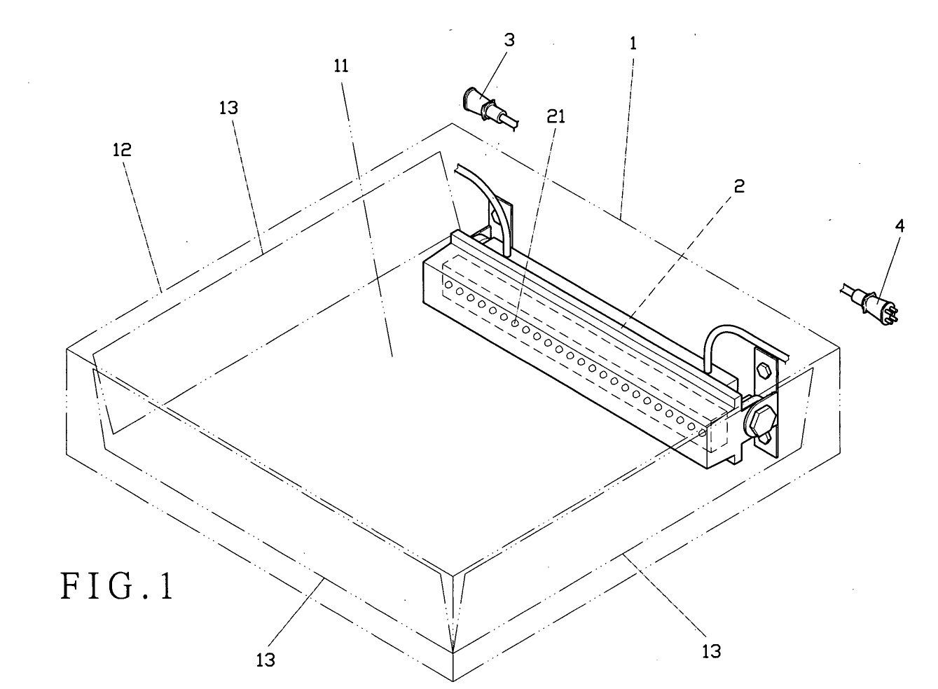

As shown in FIG. 1, a preferred embodiment of the present invention comprises a box 1, a lighting source 2, an input terminal 3 and an output terminal 4.

The box 1 has an inner space 11 and at least one shining surface 12 which can be made of transparent of semitransparent material. The circumferences of the inner space 11 are provided with reflection boards 13 in relation to the shining surface 12.

The lighting source 2 is disposed in the inner space 11 of the box 1 and comprises a number of light emitting diodes 21 which are combined by red, blue and green colors. The three colors of the light emitting diodes 21 are basic elements of colors that can create different colors.

The input terminal 3 is connected to the lighting source 2 and may be a plug extending outwardly from the box 1 for connection with power supply and signal.

The output terminal 4 is connected to the lighting source 2 and may be a plug extending outwardly from the box 1 for connection with the input terminal 3 of another lighting source 2 to input power supply and signal.

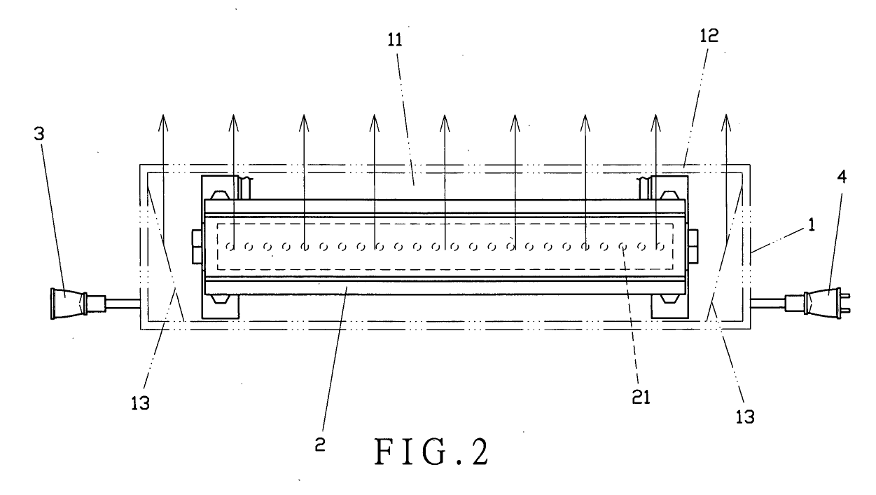

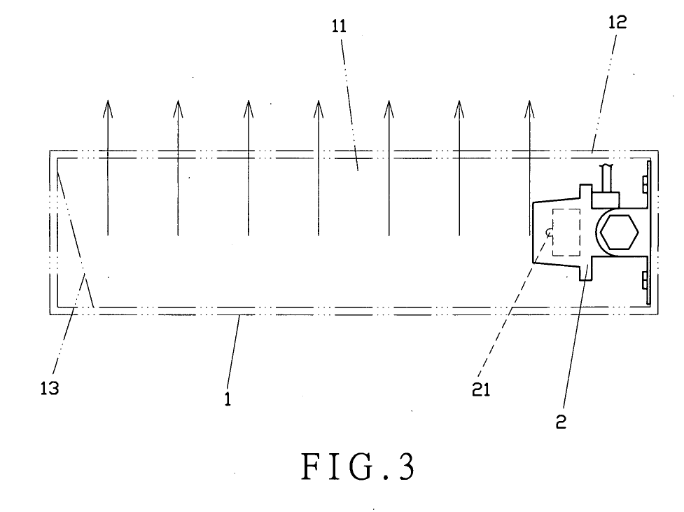

To operate, the power supply and signal are transmitted through the input terminal 3 to the lighting source 2 and activates the light emitting diodes 21 to produce lighting in different design. The reflection boards 13 in the inner space 11 of the box 1, as shown in FIGS. 2 and 3, collect the dispensing light and send to the shining surface 12. By the red, blue and green light emitting diodes 21, the lighting source 2 can produce different colors. The output terminal 4 is connected to the input terminal 3 of the lighting source 2 of another box 1 to transmit power supply and signal. Thus the box 1 can be added or decreased as desired.

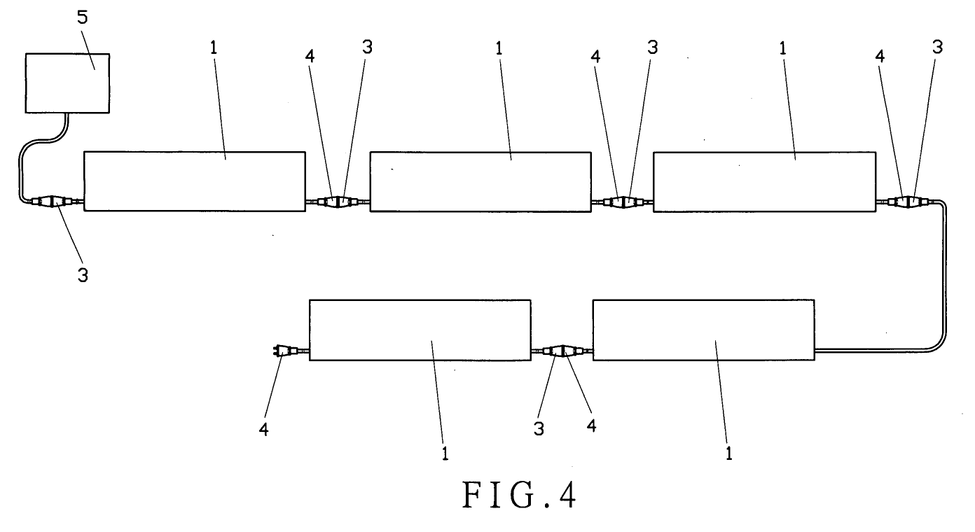

The present invention may be a combination of molding light box assembly. A number of boxes 1 are connected, as shown in FIG. 4. The input terminal 3 of the lighting source 2 of the box 1 is connected to a control unit 5. The control unit 5 sends power supply and signal through the input terminal 3 to the output terminal 4. By continuing this step, all boxes 1 are connected together. The control unit 5 controls all light emitting diodes 21 in all of the boxes 1 to turn them on/off, blinking and the strength of the illumination, etc. The output terminal 4 sends power supply and signal to the input terminal 3 of another box 1, enabling the design to add or decrease boxes 1 as desired. The control unit 5 may be operated manually in order to create an effect for advertisement and propaganda purposes.

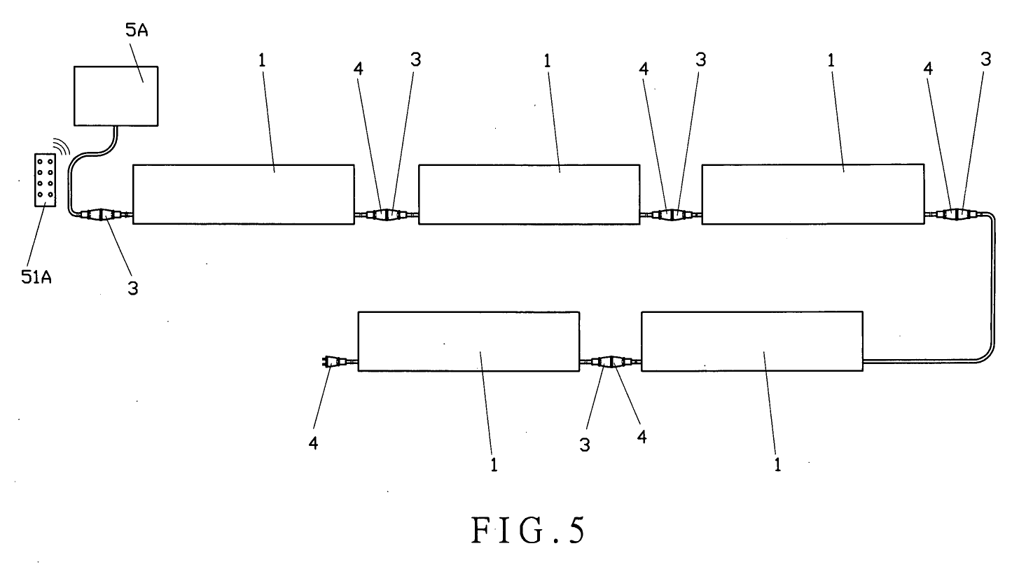

FIG. 5 shows a second embodiment of the present invention. The input terminal 3 of the lighting source 2 is connected to a control unit 5A. The control unit 5A transmits power supply and signal through the input terminal 3, and then through the output terminal 4 to the input terminal 3 of another box 1, thus the whole boxes 1 are connected together. The control unit 5A uses a remote controller 51A for convenience.

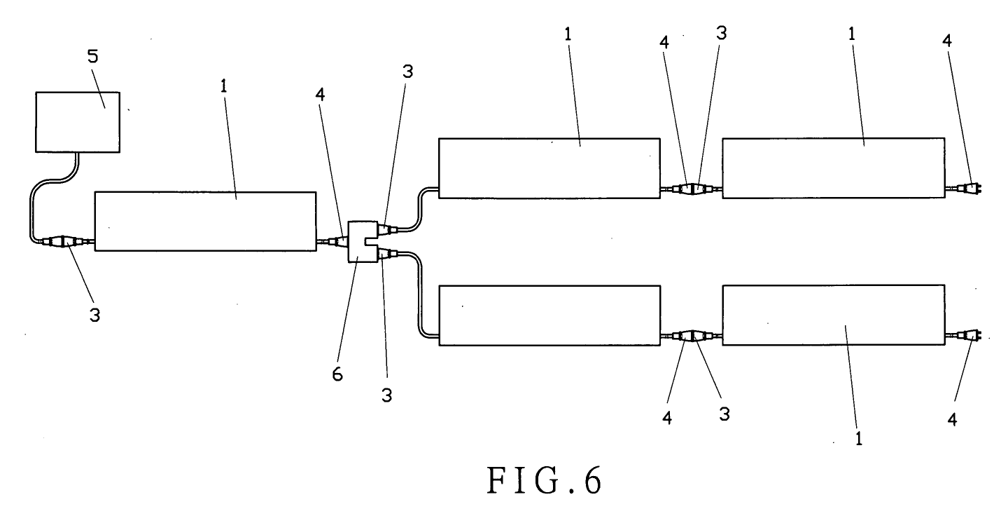

FIG. 6 shows a third embodiment of the present invention. The output terminal 4 of the lighting source 2 of the box 1 is connected to a splitter 6. The splitter 6 comprises at least two output terminals for a parallel connection of the input terminals 3 of other boxes 1. According to the above description, we realize that the connection between boxes 1 can be in series or in parallel and they all can reach to the same goal.

What is claimed is:

1. A molding light box comprising:
a box having an inner space, said box comprising at least one shining surface;
a light source disposed in said inner space, said light source comprising light emitting diodes;
an input terminal connected to said light source for inputting power supply and signal; and
an output terminal connected to said light source for outputting power supply and signal.

2. The molding light box, as recited in claim 1, wherein the circumferences of said inner space of said box are provided with reflection boards in relation to said shining surface.

3. The molding light box, as recited in claim 1, wherein said light emitting diodes are a combination of red, blue and green colors.

4. The molding light box, as recited in claim 1, wherein said input terminal is a plug.

5. The molding light box, as recited in claim 1, wherein said output terminal is a plug.

6. A molding light box assembly comprising:
a plurality of boxes, each box comprising an inner space to accommodate a light source, said light source comprising an input terminal and an output terminal, each box being connected by said input terminal and said output terminal for power and signal transmission; and
a control unit, said control unit controlling change of said light sources of said boxes.

7. The molding light box assembly, as recited in claim 6, wherein said boxes are connected in series.

8. The molding light box assembly, as recited in claim 6, wherein said boxes are connected in parallel.

9. The molding light box assembly, as recited in claim 6, wherein said boxes are connected in both series and parallel.

10. The molding light box assembly, as recited in claim 6, wherein said control unit has a remote controller to control said boxes.

11. The molding light box assembly, as recited in claim 6, wherein said light source of each box comprises red, blue and green light emitting diodes.
